(19) United States
(12) Patent Application Publication
(10) Pub. No.: US 2026/0063594 A1
(43) Pub. Date: Mar. 5, 2026

(54) AUXILIARY POSITIONING METHOD FOR ULTRASONIC MICROSCOPE BASED ON OPTICAL IMAGING

(71) Applicant: National Institute of Metrology, China, Beijing (CN)

(72) Inventors: Guangzhen Xing, Beijing (CN); Huanran Lu, Beijing (CN); Feiming Qian, Beijing (CN); Ping Yang, Beijing (CN)

(21) Appl. No.: 19/310,857

(22) Filed: Aug. 26, 2025

(30) Foreign Application Priority Data
Sep. 5, 2024 (CN) 202411238422.2

(51) Int. Cl. G01N 29/30; G01N 29/26

(52) U.S. Cl. CPC G01N 29/30; G01N 29/26

(57) ABSTRACT

Disclosed is an auxiliary positioning method for an ultrasonic microscope based on optical imaging, including a three-axis scanning driving device, an ultrasonic probe, and a first camera device and a second camera device for optical assisted positioning. The first camera device realizes an XY plane positioning of an ultrasonic probe using a projection matrix. A point is selected on a displayed image of the second camera device right in front, and a distance between the ultrasonic probe and a sample is obtained in real time. The XY coordinate positioning of the ultrasonic probe on a two-dimensional plane of a water tank platform and the measurement of a distance between the ultrasonic probe and the sample in a Z direction can be realized, a position of the ultrasonic probe is conveniently positioned, and an operator's concern about whether the probe collides with the sample during operation is solved.

### CROSS-REFERENCE TO RELATED APPLICATION

This application claims priority of Chinese Patent Application No. 202411238422.2, filed on Sep. 5, 2024, the entire contents of which are incorporated herein by reference.

### TECHNICAL FIELD

The present disclosure relates to the technical field of ultrasonic microscope-assisted positioning, and in particular to an auxiliary positioning method for an ultrasonic microscope based on optical imaging.

### BACKGROUND

An ultrasonic microscope is a microscopic instrument that uses ultrasonic detection technology to observe the microstructure of samples. Due to its feature of high-resolution observation of the internal structure of materials under non-destructive conditions, it is widely used as a non-destructive testing device in fields including biomedicine, materials engineering, and the electronics industry.

An ultrasonic microscope generates and emits ultrasonic waves by exciting an ultrasonic probe, and these pulse waves are transmitted to the tested sample through a coupling medium. Compared with air, ultrasonic waves have a lower attenuation in water. Moreover, water, as a coupling medium, is easy to obtain and clean. Therefore, water is often used to immerse the sample, and it is necessary to ensure that the front end of the probe is also immersed in water to guarantee that the ultrasonic waves propagate throughout the process in water.

To obtain an internal image of a sample by an ultrasonic microscope, it is necessary to make an ultrasonic probe scan in the XY plane while emitting ultrasonic waves. To form a qualified acoustic image, the scanning mechanism needs to scan back and forth above the sample. In order to obtain ideal ultrasonic microscopy results and save scanning time, it is necessary to set a suitable scanning range in advance before ultrasonic microscopy.

The traditional scanning method relies on the operator to observe the approximate position of the sample through the human eyes and move the ultrasonic probe directly above the sample to be measured. The distance between the ultrasonic probe and the sample is adjusted to maximize the reflected echo intensity near the depth to be measured of the sample, that is, to make the focus reach the depth to be measured. According to the size of the sample, a scanning range is set artificially, and the scanning range is centered on the position of the ultrasonic probe. In this way, the pre-preparation work of the ultrasonic microscope is completed, and the scanning task can be performed.

It is difficult to achieve accurate positioning only by the human eyes of the operator, and the positioning time is long. The error of the human eyes in determining the position is large, resulting in low positioning accuracy, which in turn leads to the deviation of the scanning range of the probe, and it is easy for the scanned image to fail to completely cover the sample. In order to ensure that the sample is completely covered, it is often necessary to increase the scanning range, which not only prolongs the scanning time, but also reduces the overall work efficiency. Especially when the sample size is unclear, it may be necessary to change the scanning range many times to obtain a complete image of the sample. For operators, especially those who lack relevant theoretical knowledge, when adjusting the distance between the ultrasonic probe and the sample, that is, when adjusting the Z direction height of the probe, frequent observation is due to fear of contact and collision between the probe and the sample, which reduces the detection efficiency.

In addition, in the actual operating environment, the distance between the position of the operator and the ultrasonic microscope may be far, which makes the experimenter need to move back and forth frequently in order to observe the position of the sample and the probe, further reducing the detection efficiency.

In practical applications, the sample usually needs to cover most of the area of the image, and the traditional method inevitably adjusts the scanning range many times. For factories that need to inspect tens of thousands of workpieces every day, this inefficient scanning method is particularly unacceptable. In large-scale production environment, detection efficiency directly affects production efficiency and cost control. Frequent eye positioning and multiple scans not only increase the time cost, but can also lead to quality problems due to human error.

A China disclosure patent application with a publication number of CN204536278U (application number of CN201520204930.9) discloses a device for positioning an ultrasonic probe by using a camera. In this disclosure, the actual position of the probe needs to be converted, which increases the complexity and time cost of operation; In addition, during the scanning process, the device can not display the position of the ultrasonic probe in real time, which makes it difficult for operators to monitor and adjust the accurate position of the probe in real time.

This disclosure can only guarantee the positioning of the ultrasonic probe directly above the center of the sample, but the setting of the scanning range still requires artificial estimation. This is particularly problematic for samples with ambiguous dimensions, which tend to lead to excessively large scanning ranges, thereby increasing scanning time and complexity of data processing.

### SUMMARY

An objective of the present disclosure is to provide a device for realizing fast, accurate and simple probe positioning by using a camera for optically assisted ultrasonic probe positioning.

The present disclosure includes a three-axis scanning driving device, an ultrasonic microscope and a first camera device and a second camera device for optical assisted positioning, the first camera device is mounted directly above the ultrasonic microscope, and the second camera device is mounted directly in front of the ultrasonic microscope and parallel to an XZ plane of a water tank; the first camera device realizes an XY plane positioning of an ultrasonic probe using a projection matrix, and moves the ultrasonic probe to a real position in an actual plane corresponding thereto by selecting a point on a displayed image of the first camera device; and a point is selected on a displayed image of the second camera device right in front, and a distance between the ultrasonic probe and a sample is obtained in real time.

Further, the first camera device and the second camera device are ensured to cover an XYZ plane of the whole water tank to assist the positioning of the ultrasonic probe, and through real-time image feedback, the position of the ultrasonic probe is observed and adjusted on a camera displayed image.

Further, the three-axis scanning driving device includes an X-axis scanner, a Y-axis scanner and a Z-axis scanner; the X-axis scanner adopts a magnetic levitation guide rail driven by a linear motor, and is capable of moving a probe column and the ultrasonic probe in ±X directions; the Y-axis scanner and the Z-axis scanner are driven by stepper motors, and capable of moving the probe column and ultrasonic probe along the ±Y and Z directions; and in a scanning process, the ultrasonic probe is immersed in a water tank filled with water during scanning, and keeps a certain distance from the tested sample in a Z direction.

Further, the first camera device realizes an XY plane positioning of an ultrasonic probe using a projection matrix, including the steps of:
connecting an original image plane and a target image plane together by projection transformation to construct a Homography;
constructing two linear equations covering all parameters of the Homography H by representing the projection change by a system of linear equations:

$${x}_{i} ( {h}_{31} {X}_{i} + {h}_{32} {Y}_{i} + {h}_{33} ) = {h}_{11} {X}_{i} + {h}_{12} {Y}_{i} + {h}_{13} \\ {y}_{i} ( {h}_{31} {X}_{i} + {h}_{32} {Y}_{i} + {h}_{33} ) = {h}_{21} {X}_{i} + {h}_{22} {Y}_{i} + {h}_{23}$$

obtaining a projection matrix of a pixel coordinate system of a displayed image of the first camera device to a world coordinate system of an actual water tank platform plane to realize optical assisted positioning;
adopting a singular value decomposition (SVD) method to minimize ∥A·h−b∥, and after converting the solved vector H into the Homography H, and obtaining a projection matrix from a pixel coordinate system of a displayed image of the camera to a world coordinate system of a water tank plane; and
selecting a position on a displayed image of the camera, acquiring a coordinate value of the position in a pixel coordinate system, and converting the coordinate value to a corresponding coordinate in the world coordinate system by using the projection matrix H.

Further, a method for determining a distance between the ultrasonic probe and the sample by the second camera device using a triangular similarity principle includes the steps of: moving the ultrasonic probe to submerged water to ensure that the ultrasonic probe appears on a displayed image of the second camera device, at this time, in the world coordinate system, a distance between the probe and the second camera device in a Y direction being d₀, lowering the ultrasonic probe by a certain height d, and obtaining a pixel change value P₁ in a v direction on the displayed image of the second camera device;
changing the position of the ultrasonic probe, moving the ultrasonic probe by a distance D along a Zc axis of the camera coordinate system, that is, a negative direction of a Y axis of the world coordinate system, lowering the ultrasonic probe by a height d again, and obtaining a pixel variation value P₂ in the v direction on the displayed image of the second camera device; and according to the triangle similarity principle, it can be obtained:

$$\frac{{P}_{1}}{d} = \frac{f}{{d}_{0}} \frac{{P}_{2}}{d} = \frac{f}{D + {d}_{0}}$$

obtaining f and d₀ by solving the equations, obtaining a Y-direction coordinate y0 of the second camera device in the world coordinate system after conversion, and continuing the measurement of the distance between the ultrasonic probe and the sample;

obtaining a y coordinate value of the position of the probe by the first camera device, clicking an upper edge surface of the sample on the displayed image of the second camera device, and obtaining an ordinate v1 of the pixel point thereof; and tracking the change of the pixel value of the displayed image when the probe is lowered, and obtaining an ordinate v2 of the pixel point at a lower edge of the ultrasonic probe in real time; and

calculating a difference between the two, and calculating an actual distance between the two from the depth information of the probe to the second camera device according to the triangle similarity principle.

Compared with the related art, the present disclosure adopts the above technical solution and has the follow greatest characteristics.

In the present disclosure, by placing the two cameras directly above and in front of the water tank platform, the XY coordinate positioning of the ultrasonic probe on a two-dimensional plane of the water tank platform and the measurement of the distance Δh between the ultrasonic probe and the sample in the Z direction can be realized, the operator can conveniently position the position of the ultrasonic probe without repeated observation by human eyes, and at the same time, the operator's concern about whether the probe collides with the sample during operation is solved.

In the present disclosure, by frame selecting the scanning range on the displayed image of the first camera device by an operator, accurate range selection is realized once, and time waste and cost increase caused by adjusting the scanning range for many times are avoided.

In the present disclosure, the whole process is controlled by an operation terminal such as a personal computer (PC), and an operator does not need to move for a long distance during operation, thereby avoiding time consumption caused by meaningless movement.

### BRIEF DESCRIPTION OF THE DRAWINGS

FIG. 1 is a schematic diagram of an ultrasound microscope according to the present disclosure;

FIG. 2 is a side view of a position of a camera according to the present disclosure;

FIG. 3 is a schematic diagram of a grid distribution of a platform of the present disclosure;

FIG. 4 is an effect diagram for determining a scanning range of the present disclosure;

FIG. 5 is a flowchart of a first camera device assisted positioning of the present disclosure;

FIG. 6 is a schematic perspective projection diagram of the present disclosure; and

FIG. 7 is a schematic diagram of a distance relationship between a perspective projection space point mc and the movement of an image point m in an image plane of the present disclosure.

### DETAILED DESCRIPTION

Technical solutions in the examples of the present disclosure will be described clearly and completely in the following with reference to the attached drawings in the examples of the present disclosure. Obviously, all the described examples are only some, rather than all examples of the present disclosure. Based on the examples in the present disclosure, all other examples obtained by those ordinary skilled in the art without creative efforts belong to the protection scope of the present disclosure.

A first camera device 1 and a second camera device 2 are mounted directly above and directly in front of an ultrasonic microscope, and an ultrasonic probe is moved to a real position in an actual plane corresponding thereto by selecting a point position on a displayed image of the first camera device; and a point position is selected on a displayed image of the second camera device directly in front, a distance between the ultrasonic probe and a sample is obtained in real time, and an operator is allowed to freely select a scanning range on the displayed image of the first camera device, thereby quickly setting an optimum scanning range of the sample.

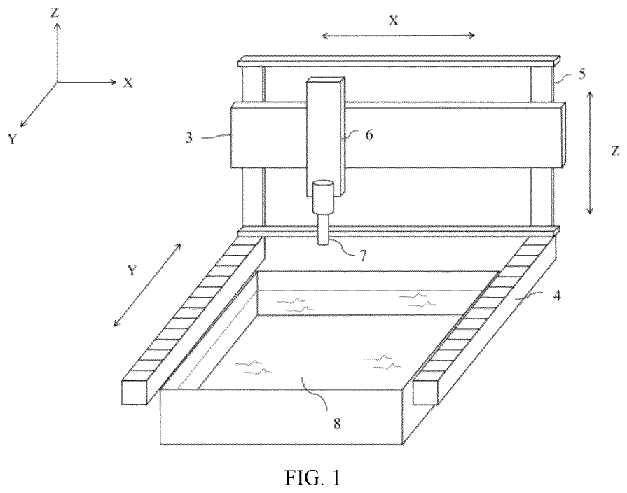

FIG. 1 is a schematic diagram of a scanning mode of the ultrasonic microscope, specifically showing a part of the ultrasonic microscope, and including a three-axis scanning driving device and the ultrasonic probe. An X-axis scanner 3 adopts a magnetic levitation guide rail driven by a linear motor and can move a probe column 6 and the ultrasonic probe 7 in ±X directions; a Y-axis scanner 4 is driven by a stepping motor and can drive the X-axis scanner 3, a Z-axis scanner 5, the probe column 6 and the ultrasonic probe 7 to move along ±Y directions; and the Z-axis scanner 5 is also driven by the stepping motor and can drive the X-axis scanner 3, the probe column 6 and the ultrasonic probe 7 to move in ±Z directions. The ultrasonic probe 7 has a cylindrical shape and is immersed in a water tank 8 filled with water during scanning, and keeps a certain distance from a tested sample 9 in a Z direction. Through this scanning mode, the ultrasonic probe 7 can obtain a planar image of the sample at a certain depth to be measured.

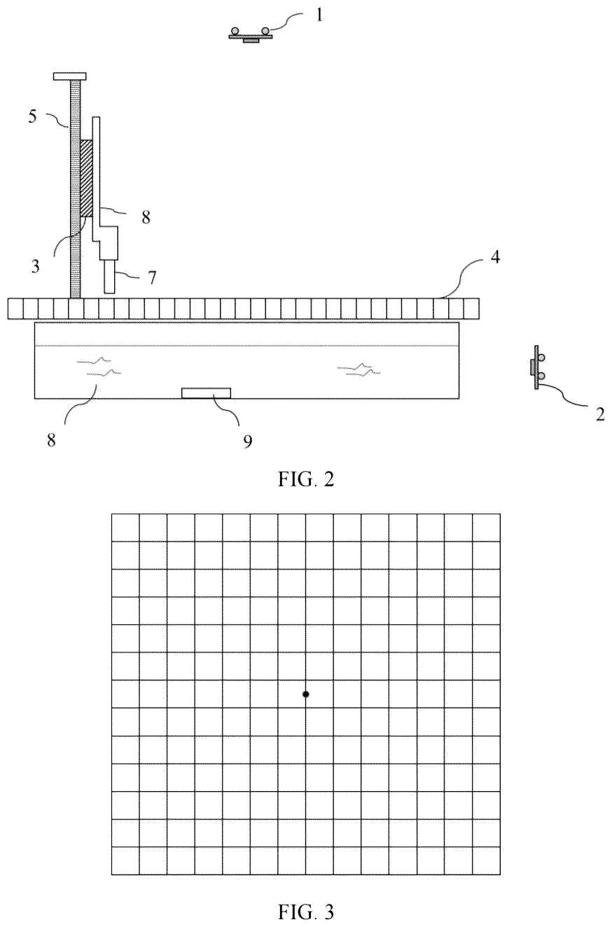

In the present disclosure, the first camera device is mounted at a top of the ultrasonic microscope device, positioned directly above a center of the water tank platform, and keeps a certain distance from the three-dimensional scanning mechanism to avoid collision; the second camera device is mounted in front of the ultrasonic microscope device and parallel to an XZ plane of the water tank. FIG. 2 shows a side view of the ultrasound microscope including locations of the cameras. Specifically, the location design of the cameras ensures that the cameras can cover an XYZ plane of the whole water tank, providing a comprehensive viewing angle to assist ultrasonic probe positioning. Through real-time image feedback, the cameras can assist the operator to observe and adjust the position of the ultrasonic probe on images displayed by the cameras, ensuring the accuracy of the scanning range and position.

As shown in FIG. 3, a scannable range of the water tank platform is 350 mm×350 mm, the platform plane is distributed in a grid shape, each grid size is 25 mm×25 mm, and a center of the first camera device is located directly above the platform.

The implementation of the present disclosure is divided into two parts: auxiliary positioning of a two-dimensional plane position of an ultrasonic probe of the first camera device and auxiliary positioning of a distance between an ultrasonic probe of the second camera device and the sample, which will be described in turn below.

In image matching and computer vision, an original image plane and a target image plane are linked by a projection transformation, which can be expressed as:

$$[ \begin{matrix}X \\ y \\ 1\end{matrix} ] = H [ \begin{matrix}X \\ Y \\ 1\end{matrix} ]$$

where His a 3×3 projection matrix, generally referred to as a Homography.

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ]$$

(X, Y) and (x, y) are coordinates of points in the original image and corresponding points in the target image. In order to facilitate the calculation of projection transformation, these point coordinates can be expressed as (X, Y, 1) and (x, y, 1) in a homogeneous coordinate system.

According to this transformation, for each set of corresponding points (xi, yi) and (Xi, Yi), the projection transformation can be represented by the following system of linear equations:

$${x}_{i} = {h}_{11} {X}_{i} + {h}_{12} {Y}_{i} + {h}_{13} \\ {y}_{i} = {h}_{21} {X}_{i} + {h}_{22} {Y}_{i} + {h}_{23} \\ l = {h}_{31} {X}_{i} + {h}_{32} {Y}_{i} + {h}_{33} .$$

To simplify the formula, two linear equations covering all parameters of the Homography H are constructed by making the following changes to each point:

$${x}_{i} ( {h}_{31} {X}_{i} + {h}_{32} {Y}_{i} + {h}_{33} ) = {h}_{11} {X}_{i} + {h}_{12} {Y}_{i} + {h}_{13} \\ {y}_{i} ( {h}_{31} {X}_{i} + {h}_{32} {Y}_{i} + {h}_{33} ) = {h}_{21} {X}_{i} + {h}_{22} {Y}_{i} + {h}_{23} .$$

Therefore, by obtaining a projection matrix of a pixel coordinate system of the displayed image of the first camera device to a world coordinate system of an actual water tank platform plane, optical assisted positioning can be realized. The pixel coordinate system is a two-dimensional planar coordinate system defined on the displayed image, with an upper left corner of the displayed image as an origin, a u-axis parallel to an X-axis of the image and horizontally to the right; and a v-axis is parallel to a Y-axis of the image and is vertically outward.

Four points with known world coordinate system coordinates are selected on the displayed image of the camera, and two-dimensional coordinates (ui, vi) of these points in the pixel coordinate system of the image are obtained, where i=1, 2, 3, 4. The selection of these points is usually relatively easy to determine based on their location in the real world. For example, in the application scenario of this device, four corner points of the water tank platform are selected as calibration points. Its corresponding two-dimensional coordinates (x, y) (in millimeters) in the world coordinate system are as follows: an upper left corner is (0, 0), a lower left corner is (0, 350), an upper right corner is (350, 0), and a lower right corner is (350, 350). In this world coordinate system, the upper left corner of the water tank is set as a coordinate origin.

As mentioned above, a total of eight linear equations are constructed from four pairs of points, and these equations are converted into matrix form, expressed as A·h=b, where h is a column vector including all elements of the Homography H:

$$h = {[ {h}_{11} {h}_{12} {h}_{13} {h}_{21} {h}_{22} {h}_{23} {h}_{31} {h}_{32} {h}_{33} ]}^{T} .$$

At this time, a dimension of a matrix A is 8×9, and there are eight known equations and nine unknowns, forming an under-constrained system (that is, the number of equations is less than the number of unknowns). In order to solve the minimum norm solution of the system, that is, the most appropriate solution, SVD method is adopted to minimize ∥A·h−b∥. After the solved vector H is converted into a 3×3 Homography H, the projection matrix from the pixel coordinate system of the displayed image of the camera to the world coordinate system of the water tank plane is obtained.

After obtaining the projection matrix H, for the position that the ultrasonic probe wants to reach, the position can be selected on the displayed image of the camera, and a coordinate value (u, v) of the point in the pixel coordinate system can be obtained. The projection matrix H is used to convert (u, v) to a corresponding coordinate (x, y) in the world coordinate system. In this way, the ultrasonic probe can be moved to a specified position, thereby realizing auxiliary positioning.

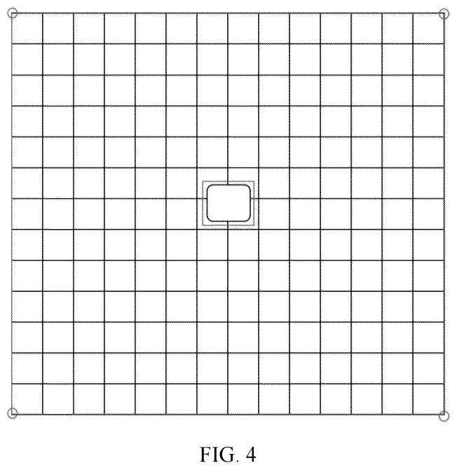

A scanning range is set by the projection matrix H. For the sample that appears in the displayed image, the required scanning area is framed. From the pre-obtained projection matrix H, the size and position of this framed area are mapped into the world coordinate system, thereby determining a true scanning range. Next, by calculating a geometric center of the scanning range, the ultrasonic probe is moved to this center position to ensure the scanning coverage is accurate, and the focusing and scanning tasks of the ultrasonic probe can be performed. The final display effect of this step is shown in FIG. 4.

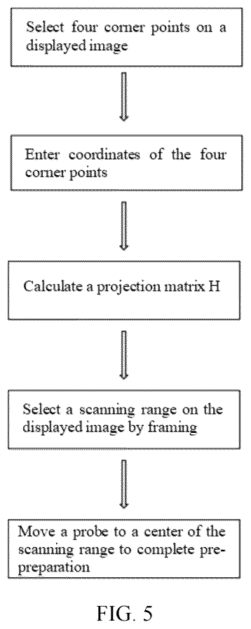

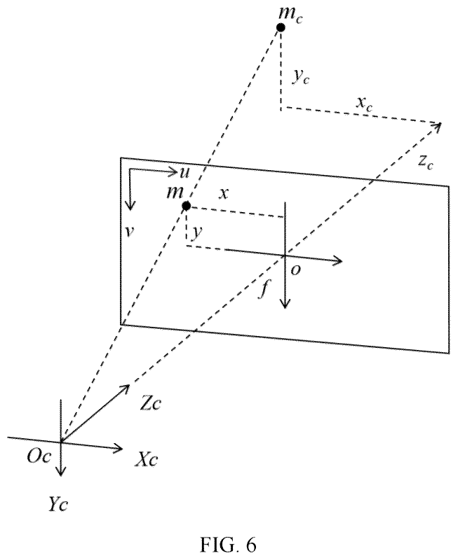

To sum up, a flow of optically assisted positioning of the ultrasonic probe in the XY plane by using the first camera device is shown in FIG. 5.

Next, a distance Δh between the ultrasonic probe and the sample is obtained by the second camera device. The first camera device acquires a two-dimensional plane coordinate (x, y) of the sample, and a Z-direction distance between the sample and the first camera device does not affect the application of the Homography H. However, when measuring the distance between the ultrasonic probe and the sample, the positional relationship between the probe and the second camera device, that is, the depth information of the probe, is crucial.

In order to make a three-dimensional object present an image that conforms to the observation effect of human eyes on the displayed image of the camera, perspective projection is usually used to simulate the camera imaging. In order to simplify the calculation, a pinhole camera model is used to describe the perspective projection imaging process. The pinhole camera model is a simplified optical imaging model, and the basic principle is central perspective projection. The image plane is where the object is actually imaged, behind the camera. A virtual image plane symmetrical to the image plane about a center of the camera is introduced in front of the camera to facilitate the subsequent analysis and calculation. The virtual image plane is perpendicular to a main optical axis of the camera and is separated from the camera by f, which is a focal length of the camera.

In order to obtain the depth information of the probe, a camera coordinate system is introduced. The camera coordinate system is a three-dimensional coordinate system established with an optical center of the camera as a reference point. Different from the world coordinate system, the camera coordinate system takes the optical center of the camera as a coordinate origin, a main optical axis as a Zc axis, a horizontal direction parallel to the image plane as an Xc axis, and a vertical direction parallel to the image plane as a Yc axis, and the coordinate values are represented by (xc, yc, zc). The camera coordinate system to the pixel coordinate system of the displayed image is A real projection process, as shown in FIG. 6. According to the triangle similarity principle, a relationship between a space point mc (xc, yc, zc) and an image point thereof m (x, y, f) is inferred as follows:

$$x = f \frac{{x}_{c}}{{z}_{c}} \\ y = f \frac{{y}_{c}}{{z}_{c}} .$$

When the focal length f of the camera is fixed, an image point position of the spatial point on the displayed image is only related to zc, that is, the depth information of the probe. The position of the ultrasonic probe in the world coordinate system can be obtained by the first camera device, and in order to obtain the zc of the probe in the camera coordinate system, a position of the second camera device in the world coordinate system needs to be determined in advance.

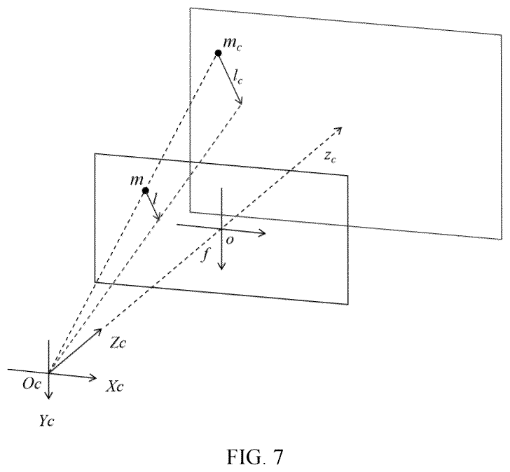

For purely monocular vision ranging, a definite length must be known. It can be seen from FIG. 7 that the spatial point mc is moved by a certain distance lc in any direction in a plane with a constant depth zc, a distance l moved by the image point m in the image plane satisfies:

$$l = {l}_{c} \frac{f}{{z}_{c}} .$$

According to the above relationship, the auxiliary positioning of the second camera device is realized. The ultrasonic probe is moved into the submerged water to ensure that the ultrasonic probe appears on the displayed image of the second camera device. At this time, in the world coordinate system, a distance between the probe and the second camera device in a Y direction is d₀. For the convenience of observation, the probe is to be placed in a middle of the displayed image as much as possible. First, the ultrasonic probe is lowered by a certain height d, and a pixel change value P₁ in a v direction is obtained on the displayed image of the second camera device; the position of the ultrasonic probe is changed, the ultrasonic probe is moved by a distance D along a Zc axis of the camera coordinate system, that is, a negative direction of a Y axis of the world coordinate system, the ultrasonic probe is lowered by a height d again, and a pixel variation value P₂ in the v direction on the displayed image of the second camera device is obtained; and according to the triangle similarity principle, it can be obtained:

$$\frac{{P}_{1}}{d} = \frac{f}{{d}_{0}} \frac{{P}_{2}}{d} = \frac{f}{D + {d}_{0}}$$

f and d₀ can be obtained by solving the equations, a Y-direction coordinate y0 of the second camera device in the world coordinate system is obtained after conversion, and the measurement of the distance between the ultrasonic probe and the sample is continued. A y coordinate value of the position of the probe is obtained by the first camera device, an upper edge surface of the sample is clicked on the displayed image of the second camera device, and an ordinate v1 of the pixel point thereof is obtained; and the change of the pixel value of the displayed image is tracked when the probe is lowered, and an ordinate v2 of the pixel point at a lower edge of the ultrasonic probe is obtained in real time. A difference between the two is calculated, and an actual distance between the two from the depth information of the probe to the second camera device is calculated according to the triangle similarity principle.

The above contents are merely instances and illustrations of the structure of the present disclosure. Those skilled in the art make various modifications, supplements or substitutes in a similar way to the specific examples described herein. As long as these changes do not deviate from the structure of the present disclosure or exceed the scope defined by the claims, they shall fall within the protection scope of the present disclosure.

1. An auxiliary positioning method for an ultrasonic microscope based on optical imaging, comprising a three-axis scanning driving device, an ultrasonic microscope and a first camera device and a second camera device for optical assisted positioning, mounting the first camera device directly above the ultrasonic microscope, and mounting the second camera device directly in front of the ultrasonic microscope and parallel to an XZ plane of a water tank; for the first camera device, realizing an XY plane positioning of an ultrasonic probe using a projection matrix, and moving the ultrasonic probe to a real position in an actual plane corresponding thereto by selecting a point on a displayed image of the first camera device; and selecting a point on a displayed image of the second camera device right in front, and obtaining a distance between the ultrasonic probe and a sample in real time;
for the first camera device, realizing an XY plane positioning of an ultrasonic probe using a projection matrix, comprising the steps of:
connecting an original image plane and a target image plane together by projection transformation to construct a Homography;
constructing two linear equations covering all parameters of the Homography H by representing the projection change by a system of linear equations:
$${x}_{i} ( {h}_{31} {X}_{i} + {h}_{32} {Y}_{i} + {h}_{33} ) = {h}_{11} {X}_{i} + {h}_{12} {Y}_{i} + {h}_{13} \\ {y}_{i} ( {h}_{31} {X}_{i} + {h}_{32} {Y}_{i} + {h}_{33} ) = {h}_{21} {X}_{i} + {h}_{22} {Y}_{i} + {h}_{23}$$
obtaining a projection matrix of a pixel coordinate system of a displayed image of the first camera device to a world coordinate system of an actual water tank platform plane to realize optical assisted positioning;
adopting a singular value decomposition (SVD) method to minimize ∥A·h−b∥, and after converting the solved vector h into the Homography H, and obtaining a projection matrix from a pixel coordinate system of a displayed image of the camera to a world coordinate system of a water tank plane;
selecting, for each set of corresponding points in the original image and the target image whose coordinates are (Xi, Yi) and (xi, yi), four sets of suitable points (Xi, Yi) and (xi, yi), where i=1, 2, 3, 4, constructing eight linear equations, and converting the equations into matrix form, expressed as A·h=b, where h is a column vector comprising all elements of the Homography H, b is a zero vector, and matrix A is an under-constrained system of 8×9; and
selecting a position on a displayed image of the camera, acquiring a coordinate value of the position in a pixel coordinate system, and converting the coordinate value to a corresponding coordinate in the world coordinate system by using the projection matrix H.

2. The auxiliary positioning method for an ultrasonic microscope based on optical imaging according to claim 1, wherein the first camera device and the second camera device are ensured to cover an XYZ plane of the whole water tank to assist the positioning of the ultrasonic probe, and through real-time image feedback, the position of the ultrasonic probe is observed and adjusted on a camera displayed image.

3. The auxiliary positioning method for an ultrasonic microscope based on optical imaging according to claim 1, wherein the three-axis scanning driving device comprises an X-axis scanner, a Y-axis scanner and a Z-axis scanner; the X-axis scanner adopts a magnetic levitation guide rail driven by a linear motor, and is capable of moving a probe column and the ultrasonic probe in ±X directions; the Y-axis scanner and the Z-axis scanner are driven by stepper motors, and capable of moving the probe column and ultrasonic probe along the ±Y and Z directions; and in a scanning process, the ultrasonic probe is immersed in a water tank filled with water during scanning, and keeps a certain distance from the tested sample in a Z direction.

4. The auxiliary positioning method for an ultrasonic microscope based on optical imaging according to claim 1, wherein a method for determining a distance between the ultrasonic probe and the sample by the second camera device using a triangular similarity principle comprises the steps of: moving the ultrasonic probe to submerged water to ensure that the ultrasonic probe appears on a displayed image of the second camera device, at this time, in the world coordinate system, a distance between the probe and the second camera device in a Y direction being do, lowering the ultrasonic probe by a certain height d, and obtaining a pixel change value P₁ in a v direction on the displayed image of the second camera device;
changing the position of the ultrasonic probe, moving the ultrasonic probe by a distance D along a Zc axis of the camera coordinate system, that is, a negative direction of a Y axis of the world coordinate system, lowering the ultrasonic probe by a height d again, and obtaining a pixel variation value P₂ in the v direction on the displayed image of the second camera device; and according to the triangle similarity principle, it can be obtained:
$$\frac{{P}_{1}}{d} = \frac{f}{{d}_{0}} \\ \frac{{P}_{2}}{d} = \frac{f}{D + {d}_{0}}$$
a parameter f being a focal length of the camera, obtaining f and d₀ by solving the equations, obtaining a Y-direction coordinate y0 of the second camera device in the world coordinate system after conversion, and continuing the measurement of the distance between the ultrasonic probe and the sample;
obtaining a y coordinate value of the position of the probe by the first camera device, clicking an upper edge surface of the sample on the displayed image of the second camera device, and obtaining an ordinate v1 of the pixel point thereof; and tracking the change of the pixel value of the displayed image when the probe is lowered, and obtaining an ordinate v2 of the pixel point at a lower edge of the ultrasonic probe in real time; and
calculating a difference between the two, and calculating an actual distance Δh between the two from the depth information of the probe to the second camera device according to the triangle similarity principle.
